(19) United States
(12) Patent Application Publication
(10) Pub. No.: US 2025/0210671 A1
(43) Pub. Date: Jun. 26, 2025

(54) ORGANIC-AIR FLOW BATTERY

(71) Applicant: Schlumberger Technology Corporation, Sugar Land, TX (US)

(72) Inventor: Wenlin Zhang, Menlo Park, CA (US)

(21) Appl. No.: 18/989,457

(22) Filed: Dec. 20, 2024

Related U.S. Application Data
(60) Provisional application No. 63/613,263, filed on Dec. 21, 2023.

(51) Int. Cl. H01M 4/86; H01M 8/00; H01M 8/0202; H01M 8/04186; H01M 8/1004; H01M 8/18

(52) U.S. Cl. CPC H01M 4/86; H01M 8/004; H01M 8/0202; H01M 8/04186; H01M 8/1004; H01M 8/188

(57) ABSTRACT

Certain aspects of the present disclosure relate to a battery. The battery includes at least one couple of current collectors. The battery includes an organic fluid flow space and an oxygen-containing fluid flow space. The battery includes one or more membrane electrode assemblies (MEAs). Each MEA includes an oxygen electrode, where the oxygen electrode is configured to catalyze a redox reaction of the oxygen-containing fluid and an oxygen evolution reaction. Each MEA also includes an ion conducting membrane and/or a porous separator paper, where the membrane or separator separates the oxygen electrode from the organic fluid flow space. The battery includes positive electrode terminals electrically connected to at least one MEA and at least one or more negative electrode terminals, where the positive electrode terminal and the negative electrode terminal are configured to generate an electrical current in response to external electrical loads or to a voltage applied to across positive and negative electrode terminals in response to a charge step associated redox reaction.

### CROSS-REFERENCE TO RELATED APPLICATIONS

This application claims priority to U.S. Provisional Patent Application No. 63/613,263, filed on Dec. 21, 2023 which is hereby incorporated by reference in its entirety for all intents and purposes by this reference.

### BACKGROUND

### Field of the Disclosure

Aspects of the present disclosure relate to renewable energy and, more particularly, to organic and air flow batteries.

### Description of Related Art

A battery converts chemical reactions into electrical power. Primary batteries utilize an irreversible chemical reaction. These batteries cannot be reused and must be disposed of after the chemical reaction is complete. Secondary batteries can be recharged and may be reused many times.

Reversible electrode reduction-oxidation (redox) reactions provide for secondary battery that can store and release energy through reversible electrode redox reactions. Redox reactions involve the transfer of electrons between chemical species and current collector electrodes. On cathode, the battery is to store energy when the reactants are oxidized and release energy when the reactants are reduced. On anode, the battery stores energy when the reactants are reduced and releases energy when the reactants are oxidized. One type of redox battery is a redox flow battery. A redox flow battery stores energy in two separate electrolyte solutions, each containing electroactive species that can undergo redox reactions. These solutions are stored in separate tanks and pumped through a cell where the redox reactions occur. Redox flow batteries have the advantage of being scalable and capable of producing and storing energy for long-duration usage.

Conventional redox flow batteries require large footprints for the electrolyte storage tanks. Conventional redox flow batteries also require inorganic materials that may be expensive to procure and/or potentially hazardous to the environment. Consequently, there exists a need for further improvements for a redox battery.

### SUMMARY

One aspect provides an organic-oxygen reduction-oxidation (redox) flow battery. The organic-oxygen reduction-oxidation (redox) flow battery includes current collector. The battery includes an organic-containing fluid flow space for flowing an organic-containing fluid including at least an organic redox-active species. The battery includes an oxygen-containing fluid flow space for flowing an oxygen-containing fluid. The battery includes one or more membrane electrode assemblies (MEAs). Each MEA includes an oxygen electrode, wherein the oxygen electrode is configured to catalyze an oxygen reduction reaction (ORR) of oxygen of the oxygen-containing fluid and an oxygen evolution reaction (OER); and a membrane or separator, wherein the membrane or separator separates the oxygen electrode from the organic-containing fluid flow space while allowing the transport of ions between the oxygen electrode and the organic-containing fluid flow space. The battery includes a positive electrode terminal electrically connected to at least one of the one or more MEAs. The battery includes a negative electrode terminal electrically connected to the organic-containing fluid, wherein the battery is configured to allow the transport of electrons between the positive and negative electrode.

Another aspect provides an organic-oxygen reduction-oxidation (redox) flow battery. The battery includes a tubular battery housing. The battery includes a plurality of tubes within the tubular battery housing. Each of the plurality of tubes defines one of an oxygen-containing fluid flow space for flowing an oxygen-containing fluid or an organic fluid flow space for flowing an organic-containing fluid including at least an organic redox-active species. The tubular battery housing and the plurality of tubes define the other one of the oxygen-containing fluid flow space or the organic fluid flow space between the plurality of tubes and the tubular battery housing. Each of the plurality of tubes comprises a MEA. Each MEA comprises an oxygen electrode configured to catalyze an ORR of oxygen of the oxygen-containing fluid and an OER. Each MEA includes a membrane or separator that separates the oxygen electrode from the organic-containing fluid flow space while allowing the transport of ions between the oxygen electrode and the organic-containing fluid flow space. The battery includes a positive electrode terminal electrically connected to at least one of the one or more MEAs. The battery includes a negative electrode terminal electrically connected to the organic-containing fluid. The battery is configured to allow the transport of electrons between the positive and negative electrode.

Another aspect provides a method of charging and discharging an organic-oxygen reduction-oxidation (redox) flow battery. The method includes flowing an organic-containing fluid including at least an organic redox-active species through an organic-containing fluid flow space of the battery and past a current collector of the battery to cause the organic redox-active species to lose electrons and to release hydrogen ions or associated metallic ions and generate organic fluid byproduct in an oxidation reaction. The method includes flowing an oxygen-containing fluid through an oxygen-containing fluid flow space and past a membrane electrode assembly to cause oxygen of the oxygen-containing fluid to gain electrons and generate hydroxide or water (depending on the pH level) in a reduction reaction. The method includes discharging an electrical current formed by the loss of electrons from the organic redox-active species and the gain of electrons by the oxygen of the oxygen-containing fluid from the battery via a positive electrode terminal and a negative electrode terminal of battery, respectively The method for battery charge steps incudes applying a voltage to the positive electrode terminal to generate an electrical current across the positive electrode terminal and the negative electrode terminal to cause the hydroxide or water byproduct to lose electrons and to release hydrogen ions in an oxidation reaction and the organic fluid byproduct to gain electrons and hydrogen ions or metallic ions in a reduction reaction.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts a schematic cross-sectional view of an organic-air redox battery in which certain aspects of the present disclosure may be applied.

FIG. 2A depicts a schematic cross-sectional view of a monopolar design of an organic-air redox flow battery in which certain aspects of the present disclosure may be applied.

FIG. 2B depicts a schematic isometric view of a monopolar design of an organic-air redox flow battery in which certain aspects of the present disclosure may be applied.

FIG. 3A depicts a schematic isometric view of a bipolar design of an organic-air redox flow battery in which certain aspects of the present disclosure may be applied.

FIG. 3B depicts a schematic isometric view of a negative end of a bipolar design of an organic-air redox flow battery, in which certain aspects of the present disclosure may be applied.

FIG. 3C depicts a schematic cross-sectional view of the bipolar design of the organic-air redox flow battery, in which certain aspects of the present disclosure may be applied.

FIG. 3D depicts exploded views of a membrane electrode assembly, in which certain aspects of the present disclosure may be applied.

FIG. 4A depicts a schematic isometric view of an organic-air redox flow battery in a tube configuration in which certain aspects of the present disclosure may be applied.

FIG. 4B depicts a schematic cross-sectional view of a tube configuration for an organic-air redox flow battery in which certain aspects of the present disclosure may be applied.

FIG. 5A depicts a schematic cross-sectional view of a tube configuration for an organic-air redox flow battery in which certain aspects of the present disclosure may be applied.

FIGS. 5B-5E depict schematic exploded views of material layers within a tube for organic-air redox flow battery in which certain aspects of the present disclosure may be applied.

### DETAILED DESCRIPTION

Aspects of the present disclosure provide apparatuses and systems for an organic redox flow battery. A battery utilizes one or more cells to convert chemical energy into electricity. In a rechargeable battery, the one or more cells convert electricity into stored chemical energy. Batteries may vary in number of cells, size, chemical composition, and configuration.

The techniques, methods, and systems described herein for organic redox flow batteries may be used for various scenarios. While aspects may be described with respect to a shell and tube configuration, aspects of the present disclosure may likewise be applicable to any battery design configuration.

It is advantageous to utilize organic materials in the flow battery due to the sustainability and abundant resources of the organic materials. Organic compounds may be derived from renewable resources and can be designed to have minimal environmental impact, making the flow battery a more eco-friendly energy storage solution. Additionally, the utilization of an organic material as an anode in combination with an air-oxygen cathode enables the flow battery to potentially achieve high energy and density. Further, use of an air breathing cathode enables long-lasting energy storage and higher volumetric energy density with no need of catholyte storage tanks.

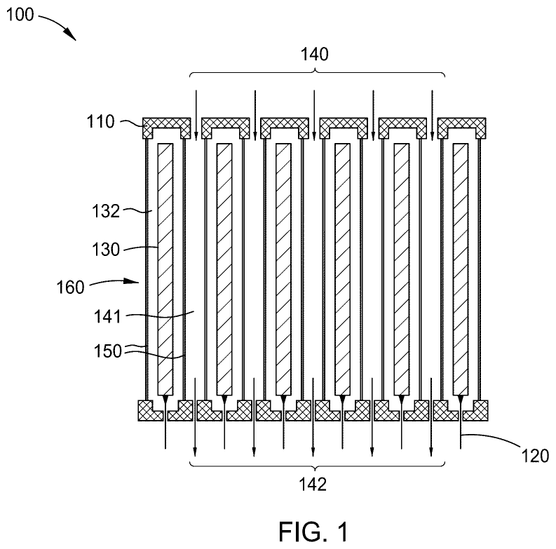

FIG. 1 depicts a schematic cross-sectional view of an organic-air redox battery 100 in which certain aspects of the present disclosure may be applied. As shown in FIG. 1, the organic-air redox battery 100 includes one or more cells. Each cell may include a housing 160 with a membrane electrode assembly 150, an organic electrode 130, a positive electrode terminal 110, and a negative electrode terminal 120. The housing 160 may be any non-reactive material such as plastic.

As shown in FIG. 1, the housing 160 may include membrane electrode assembly 150 on both sides of the housing 160. In some aspects, membrane electrode assembly 150 may include a catalyst layer, a gas diffusion layer (GDL), and a conductive current collector. The catalyst layer is loaded with oxygen electrocatalysts to enhance the electrochemical reaction of oxygen. In some aspects, the electrocatalysts in the catalyst layer have sites that are capable of catalyzing oxygen reduction reaction (e.g., referred to as ORR catalysts) and that are capable of catalyzing oxygen evolution reaction (e.g., referred to as OER catalysts). In some aspects, the electrocatalysts have one or more bifunctional active sites that catalyze both ORR and OER reactions. In some aspects, the catalyst layer may be porous. The gas diffusion layer distributes the oxygen on the catalyst layer. The conductive current collector is electrically connected to the positive electrode terminals 110.

In some aspects, the membrane electrode assembly 150 may include a separator, layered on the catalyst and facing the organic electrode 130. The separator allows for electrical separation of the oxygen electrode from the organic electrode 130, while permitting the transport of ions between the oxygen electrode and the organic electrode 130. In some aspects, the separator may be a membrane such as a proton exchange membrane, an anion exchange membrane, a micro-pore to nano-pore size engineered membrane, or a porous separator. The separator/membrane may electrically insulate the oxygen electrode and the organic electrode 130. In some aspects, the separator may be a general porous separator which may reduce the manufacturing costs of the organic-air redox battery 100.

As used herein, a MEA can refer to either an assembly of an ion-selective membrane with OER/ORR (Oxygen Evolution Reaction/Oxygen Reduction Reaction) electrodes or an assembly of a general porous separator paper with OER/ORR electrodes.

As shown in FIG. 1, the housing 160 may include an organic electrode 130 disposed within the housing 160. In some aspects, the organic electrodes 130 are coated in an organic polymer. In some aspects, the organic polymer may include redox-active organic molecules. Example of organic polymers including redox-active organic molecules include quinones, such as 2,5-Dihydroxy-1,4-benzoquinone (DHBQ), and poly(2,5-dihydroxy-1,4-benzoquinone-3,6-methylene) (PDBM). In some aspects, the organic polymer may include n-type organics such as TFSI(−) and pillared sulfonated MOF (metal organic framework).

In some aspects, the organic electrodes 130 may be the organic polymer coated on a current collector. The current collector may be a copper (Cu) foil, a copper mesh, an aluminum (Al) foil, an aluminum mesh, a nickel (Ni) foil, or a nickel mesh, a titanium (Ti) foil, or titanium mesh. In some aspects, the organic electrodes 130 may be solid organic electrodes.

In some aspects, the organic electrode 130 may be surrounded by a liquid 132 within the housing 160. The liquid 132 may fill the housing volume between the organic electrode 130 and the membrane electrode assembly 150. The liquid 132 may be an electrolyte, such as an aqueous based alkaline or acidic electrolyte and enables the transport of ions between the electrodes 130, 150.

As shown, each cell may include a positive electrode terminal 110 and a negative electrode terminal 120. The positive electrode terminals 110 are also known a cathode. The negative electrode terminal 120 are also known as the anode. In some aspects, the positive electrode terminal 110 is electrically connected to the oxygen electrodes. In some aspects, the negative electrode terminal 120 is electrically connected to the organic electrode 130.

Spacing in-between the cells of the organic-air redox battery 100 is maintained between the respective housings 160, which may be coupled to a frame structure of the organic-air redox battery 100. The spacing between the cells allows for incoming air 140 into the organic-air redox battery 100, for air flow 141 along the membrane electrode assembly 150 within the organic-air redox battery 100, and outlet air 142 from the organic-air redox battery 100. The incoming air 140 may consist entirely of oxygen or may be atmospheric air, or any other oxygen-containing gas. In some aspects, the incoming air 140 may be injected into the organic air-redox battery 100 via a fan or compressor (not shown). In some aspects, the incoming air 140 may be ambient air and free-flow into the organic-air redox battery 100. It may be advantageous to operate the organic-air redox battery 100 with free-flowing air as the incoming air 140 to simplify the organic-air redox battery 100 and reduce the size and weight of the organic-air redox battery 100 by removing the need for expensive or complex oxygen storage or circulation systems and removing the need for a catholyte tank, and reduce manufacturing and operating costs.

In operation, the organic-air redox battery 100 is capable of a charging operation in which a redox reaction stores electricity in the organic-air redox battery 100 and a discharge operation in which a redox reaction release electricity stored in the organic-air redox battery 100.

In the discharge operation, a current of electricity is formed as the air flow 141 flows past the membrane electrode assembly 150 causing a redox reaction in which the air 141 is reduced and the organic electrode 130 is oxidized. For example, a cathodic reduction reaction occurs at the membrane electrode assembly 150 and an anodic oxidation reaction occur at the organic electrode 130.

In some aspects, the air 141 flowing within the organic-air redox battery 100 is reduced on membrane electrode assemblies 150, resulting in water or hydroxide ions, depending on the pH of the liquid 132. In some aspects, oxidation of the organic electrodes 130 results in the release of protons or the associated metallic ions, electrons, and organic byproduct. For example, the oxidation of the organic electrodes 130 may result in the release of Li⁺, Na⁺, Mg²⁺, Zn²⁺, and/or Ca²⁺.

In an illustrative example, the organic electrode 130 includes DHBQ. In this example, during discharge operation, the following reduction reaction occurs at the oxygen electrodes:

2H⁺+2e⁻½O₂→H₂O (Eq. 1)

In this example, the following chemical oxidation reaction occurs at the organic electrode 130:

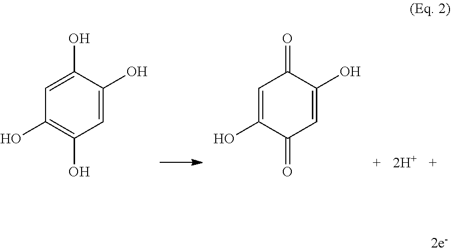 [SMILES: Oc1cc(O)c(O)cc1O ; O=C1C=C(O)C(=O)C=C1O]

Therefore, in the discharge reaction, the incoming air 140 flows into the organic-air redox battery 100 and past the membrane electrode assemblies 150. The organic material is oxidized at the organic electrode 130 though a thermodynamically driven redox reaction (e.g., as per Eq. 2). The resulting released hydrogen ions or the associated metallic ions (e.g., alkali ions) are transported through the liquid 132 and the separator to the membrane electrode assemblies 150, where the oxygen in the membrane electrode assemblies 150 is reduced (e.g., as per Eq. 1). The resulting water and excess air 142 may flow out of the organic-air redox battery 100. The release of the electrons from the organic material creates an electrical discharge current between the positive electrode terminal 110 and the negative electrode terminal 120.

In the charging operation, the organic-air redox battery 100 may be (re)charged by applying a voltage to generate an electrical current to the positive electrode terminal 110 and the negative electrode terminal 120. The electrical current may encourage the flow of electrons from the membrane electrode assemblies 150 to the organic electrode 130. The electrical current causes an oxidation reaction of the water at the membrane electrode assemblies 150. In some aspects, when the liquid 132 is acidic, the water is oxidized, outputting oxygen, protons, and electrons. In some aspects, when the liquid 132 is basic, the water is oxidized, outputting oxygen, water, and electrons. In the charging operation, a reduction reaction of the organic byproducts occurs at the organic electrode 130. The reduction reaction of the organic byproducts results in regenerating the polymer coated on the organic electrode 130.

In an illustrative example, the following chemical reduction reaction occurs at the organic electrode 130:

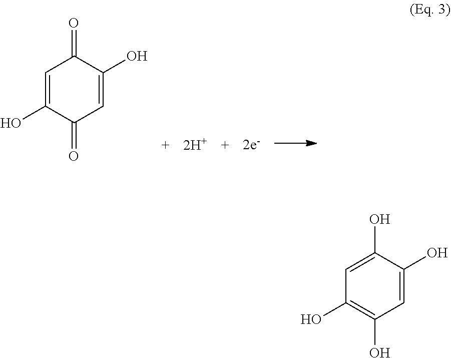 [SMILES: O=C1C=C(O)C(=O)C=C1O ; Oc1cc(O)c(O)cc1O]

In the illustrative example, the following chemical oxidation reaction happens at the membrane electrode assemblies 150:

H₂O→2H⁺+2e⁻½O₂ (Eq. 4)

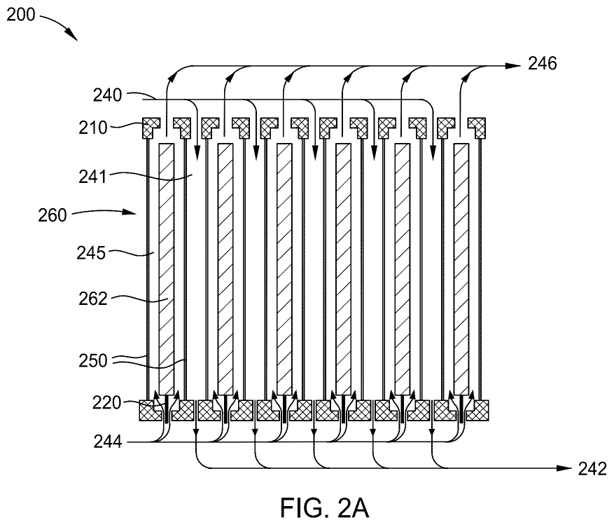

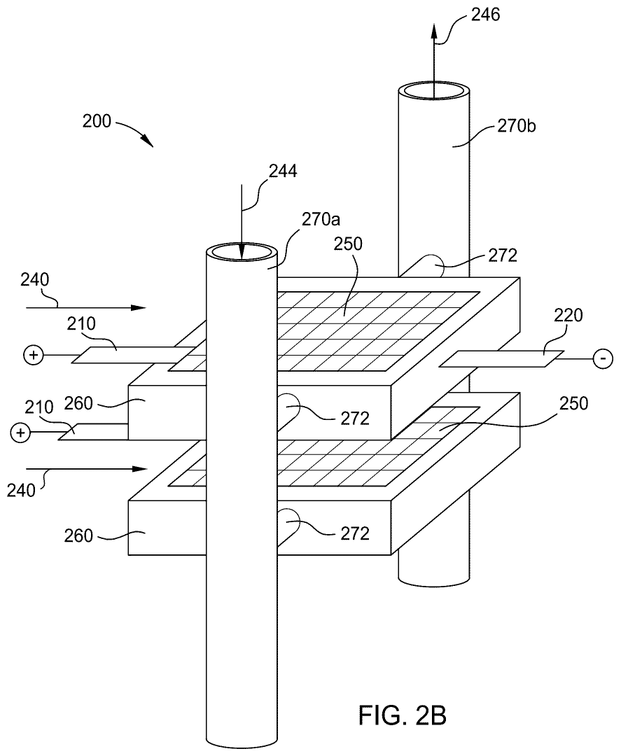

FIG. 2A depicts a schematic cross-sectional view of a monopolar design of an organic-air redox flow battery 200, in which certain aspects of the present disclosure may be applied. FIG. 2B depicts a schematic isometric view of the monopolar design of the organic-air redox flow battery 200, in which certain aspects of the present disclosure may be applied.

As shown, the monopolar organic-air redox flow battery 200 includes one or more cells. Each cell may include a housing 260, membrane electrode assembly 250, current collector 262, organic liquid 245, positive electrode terminal 210, and negative electrode terminal 220. The housing 260 may be any non-reactive material such as plastic.

As shown in FIG. 2A, the housing 260 may include an oxygen electrode assembly 250 on opposite sides of the housing 260. As shown in FIG. 2A the conductive current collector 262 may be disposed within the housing 260.

In some aspects, the membrane electrode assembly 250 includes one or more separators (not shown) layered on the interior surface of the membrane electrode assembly 250 to allow for electrical separation of the oxygen electrode and the organic electrode current collector 262, while allowing for the transport of ions between the air 241 and the organic fluid 245. In some aspects, the membrane electrode assembly 250 may be as described above with respect to the organic-air redox battery 100 of FIG. 1.

In some aspects, the housing 260 includes inlets and outlets allowing the organic liquid to flow into the volume of the housing 260 between the current collector 262 and the membrane electrode assemblies 250 (and separator/membrane). As shown in FIG. 2B, the organic-air redox flow battery 200 may include piping 270a and 270b and inlets tubes 272. In some aspects, incoming organic liquid 244 flows through into the organic-air redox flow battery 200 through piping 270a and enters the inlet to the housing 260 through inlet tubes 272 inserted into the housing 260. In some aspects, the outgoing organic liquid 246 exits the housing 260 through an outlet tube (not shown) connected to the piping 270b. In some aspects, the organic liquid, inlet tubes 272, piping 270a and 270b, and accompanying equipment (not shown) make up an organic liquid circulation system. In some aspects, the organic liquid 244, 246 may be stored in a tank or other storage system (not shown). In some aspects, the organic liquid is pumped through the organic liquid circulation system to and from one or more storage systems. In some aspects, the organic liquid circulation system may be driven by gravity or other means of circulation. In some aspects, the piping 270a, 270b may be made of non-conductive materials. In some aspects, the piping 270a, 270b may be made of materials with corrosion resistance. In some aspects, the piping 270a, 270b may be PVC or other plastics.

In FIG. 2B, piping 270a and 270b is shown to have anti-parallel flow. In some aspects, piping 270a and 270 may have parallel flow.

In some aspects, the incoming organic liquid 244 that flows into the housing 260 includes an organic material dissolved in a liquid. In some aspects, the organic material may include any of the organic materials discussed above with respect to the organic electrode 130 of FIG. 1. In some aspects, the organic material is dissolved in an electrolyte such as an aqueous based alkaline or acidic electrolyte.

Spacing in-between the cells of the organic-air redox flow battery 200 is maintained between the respective housings 260, which may be coupled to a frame structure of the organic-air redox flow battery 200. The spacing between the cells allows incoming air 240 to enter the organic-air redox flow battery 200 and flow past the membrane electrode assemblies 250 as air 241 within, and allows exhausted air 242 to exit the organic-air redox flow battery 200.

The incoming air 240 may consist entirely of oxygen or may be atmospheric air, or any other oxygen-containing gas. In some aspects, the incoming air 240 may be injected into the organic-air redox flow battery 200 via a fan or compressor (not shown). In some aspects, the incoming air 240 may free-flow into the oxygen-air redox flow battery 200.

As shown, each cell includes at least a positive electrode terminal 210 and a negative electrode terminal 220. In some aspects, the positive electrode terminal 210 is connected to a first membrane electrode assemblies 250 on a first surface of the housing 260 and to the second membrane electrode assemblies 250 on the second surface of the housing 260. The negative electrode terminals 220 and positive electrode 210 can be connected in series, i.e., the negative electrode 220 is electrically connected to both adjacent positive electrode 220 (ie both positive electrodes of the cell), and so on. This connection gives higher system output voltage. In addition, the negative and positive electrodes can also be connected in parallel, i.e., all negative terminals and all positive terminals are bundled together, respectively to provide higher current for the system.

In operation, the organic-air redox flow battery 200 is capable of a charging operation in which a redox reaction stores electricity in the organic-air redox flow battery 200 and a discharge operation in which a redox reaction release electricity stored in the organic-air redox flow battery 200.

During the discharge operation, the organic liquid 244 is flowed into the housing 260 (e.g., via piping 270a and inlet tubing 272) and the air 241 is flowed into the battery 200 past the membrane electrode assemblies 250 on both sides of 260. The organic liquid 245 (or anolyte) is oxidized (e.g., as per Eq. 2) at the conductive current collector 262, generating protons, electrons, and organic byproduct. Thus, outgoing organic liquid 246 (e.g., via the outlet tubing and the piping 270b) may be a mixture of dissolved organic polymer in an electrolyte along with organic byproduct. The resulting released hydrogen ions the associated metallic ions of the oxidization reaction are transported in the anolyte through the separator to the membrane electrode assemblies 250 where the oxygen in air 241 is reduced (e.g., as per Eq. 1), generating water or hydroxide ions. Thus, the outgoing air 242 may be a mixture of oxygen, atmospheric air, water vapor, and liquid water. This creates an electrical current between the positive electrode terminal 210 and the negative electrode terminal 220.

In the charge operation, a voltage is applied to generate an electrical current between the positive electrode terminal 210 and the negative electrode terminal 220, encouraging the flow of electrons from the membrane electrode assembly 250. In the charge operation, the water created from the discharge reaction is oxidized, resulting in oxygen and electrons and protons in acidic media or in basic media hydroxide ion is oxidized, resulting oxygen and electrons and water formation. The electrons flow to the organic byproduct, where the organic byproduct is reduced to regenerate the organic liquid anolyte 245.

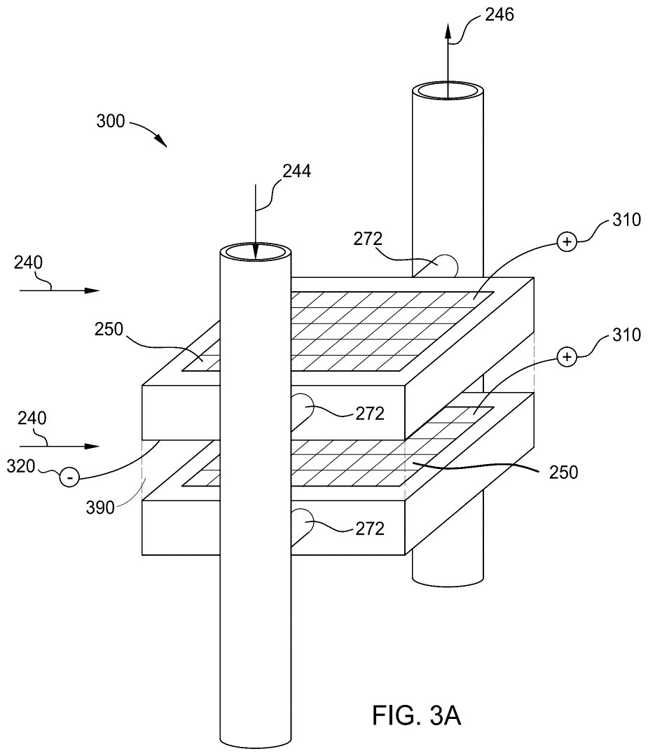

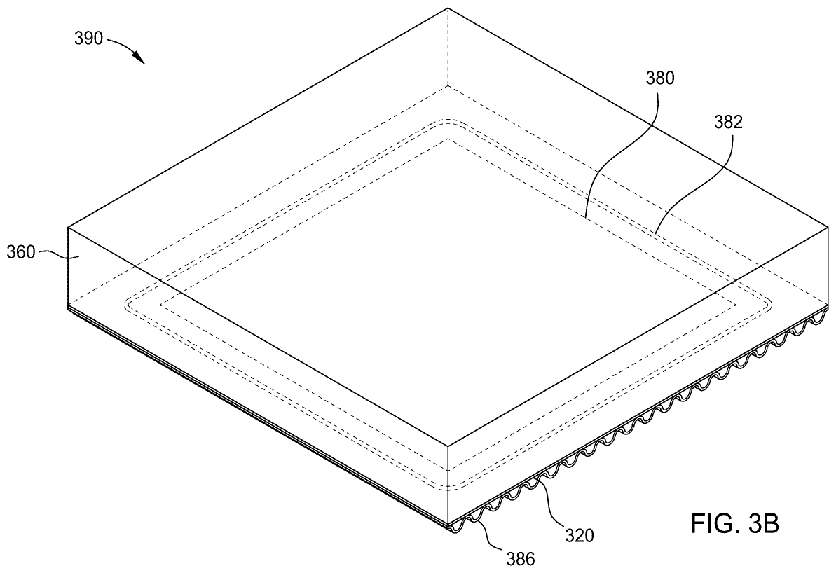

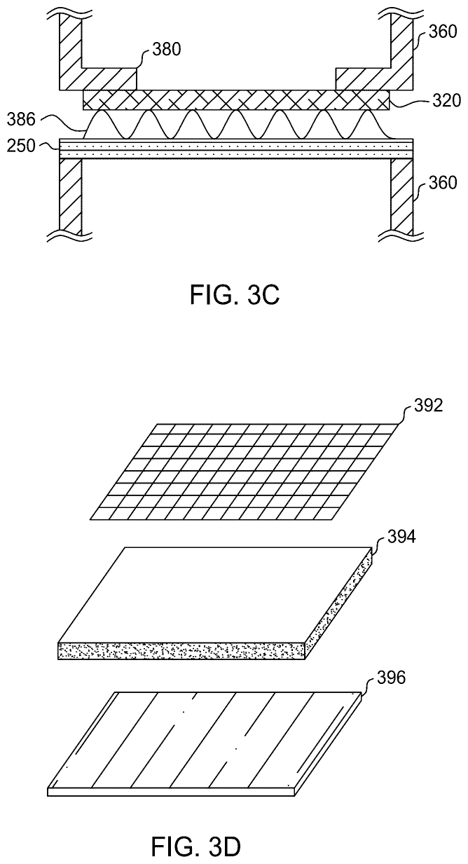

FIG. 3A depicts a schematic isometric view of a bipolar design of an organic-air redox flow battery 300, in which certain aspects of the present disclosure may be applied. FIG. 3B depicts a schematic isometric view of a negative end 390 of the bipolar design of the organic-air redox flow battery 300, in which certain aspects of the present disclosure may be applied. FIG. 3C depicts a schematic cross-sectional view of the bipolar design of the organic-air redox flow battery 300, in which certain aspects of the present disclosure may be applied.

As shown, the bipolar organic-air redox flow battery 300 includes similar components as the monopolar organic-air redox flow battery 200 illustrated in FIG. 2A and FIG. 2B. In the bipolar organic-air redox flow battery 300, the membrane oxygen electrode assembly 250 may be electrically connected to a positive electrode terminal 310. In some aspects, the membrane oxygen electrode assembly 250 may be layered with one or more materials to function as the positive electrode terminal 310. The arrangement of the positive electrode terminal 310 and the negative electrode terminal 320 (e.g., a nickel or titanium metal sheet) in a cell of organic-air redox flow battery 300 is discussed in more detail below with respect to FIG. 3B.

As shown in FIG. 3B, the housing 360 may include an opening 380 that provides contact between the organic liquid 245 (not shown) within the housing 360 and a negative electrode terminal 320. A sealing element 382 may seal the opening 380 from leakage of the organic liquid 245 from the housing 360.

The negative electrode terminal 320 may be a thin layer of metal, such as nickel (Ni), titanium (Ti), stainless steel, graphite, or any other metal suitable for performance as an electrode.

One or more contacts 386 may be disposed under the negative electrode terminal 320. The contacts 386 may be in a “waving,” “zig-zag,” or other compressible shape (e.g., forming tubes for oxygen-containing fluid flow 240 (e.g., the contacts 386 may form tubular conduits). In some aspects, the contacts 386 may be a single layer or multiple layers. The contacts 386 provide contact with the positive electrode terminal 310 of an adjacent cell via direct mechanical or electrical contact with reinforced compression. For example, the negative end 390 of the bipolar design of the organic-air redox flow battery 300 may be disposed on the positive end of an adjacent cell, as shown in FIG. 3A and FIG. 3C. As shown in FIG. 3C, the contacts 386 provide contact between membrane electrode assembly 250 and negative electrode terminal 320.

FIG. 3D depicts exploded views of a membrane electrode assembly 250, in which certain aspects of the present disclosure may be applied. As shown, the positive electrode 310 of the membrane electrode assembly 250 may be a metal screen 392. The metal screen 392 may be nickel, titanium, copper, or other suitable metal. The membrane electrode assembly 250 includes a separator 396 (or membrane) layer. The membrane electrode assembly 250 includes an oxygen electrode 394 layer between the positive terminal 310 and the separator 396 layer.

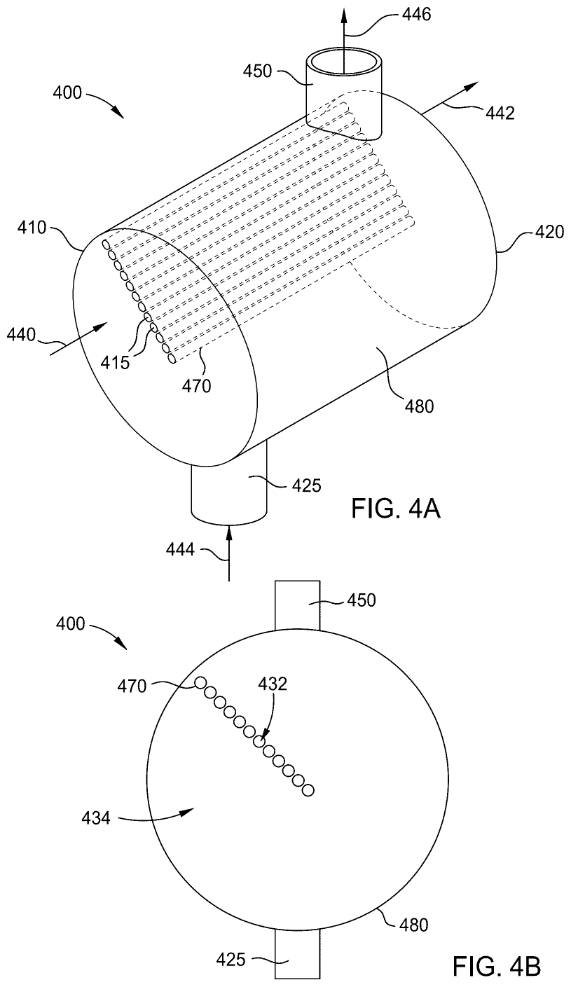

FIG. 4A depicts a schematic isometric view of an organic-air redox flow battery 400 with air flow and organic flow in a tube configuration in which certain aspects of the present disclosure may be applied. FIG. 4B depicts a schematic cross-sectional view of the tube configuration for the organic-air redox flow battery 400 in which certain aspects of the present disclosure may be applied. The organic-air redox flow battery 400 may be an example tube configuration of the organic-air redox battery 100 of FIG. 1, the monopolar organic-air redox flow battery 200 of FIGS. 2A-2B, or the bipolar organic-air redox flow battery 300 of FIGS. 3A-3B.

As shown, the organic-air redox flow battery 400 may include positive electrode terminals 410 and negative electrode terminals 420. In FIG. 4A, the positive electrode terminals 410 and the negative electrode terminals 420 are shown as the ends of a housing 480 of the organic-air redox flow battery 400. In some aspects, the positive electrode terminals 410 and negative electrode terminal 420 may be flanges. In some aspects, the terminals positive electrode 410 and the negative electrode 420 may be any suitable form of electrode terminal electrically coupled to the organic-air redox flow battery 400.

As shown in FIG. 4A, the organic-air redox flow battery 400 includes multiple tubes 470 that run longitudinally across the length of the housing 480 from a respective inlet 415 to a respective outlet (not shown). Incoming air 440, or other oxygen containing gas, flows into the organic-air redox flow battery 400 through inlets 415, then flows through the tube interiors 432 (shown in FIG. 4B), and the outgoing air 442 flows out of the tubes 470 through the outlets (not shown) of the tubes 470.

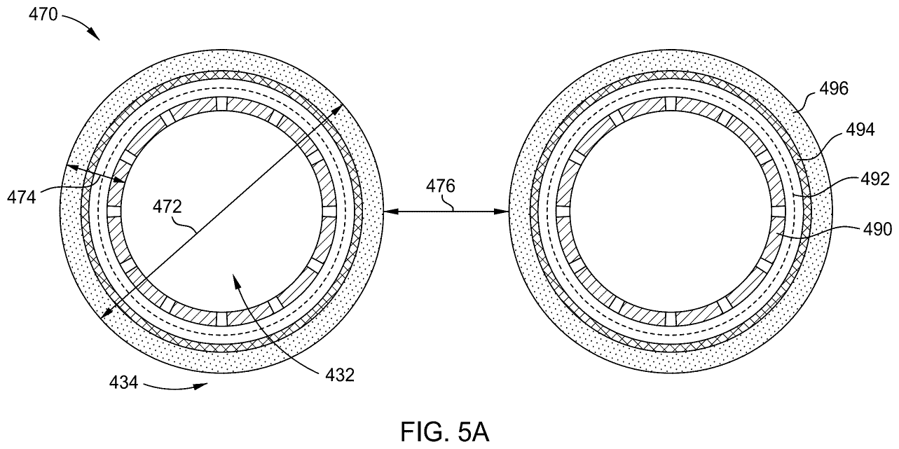

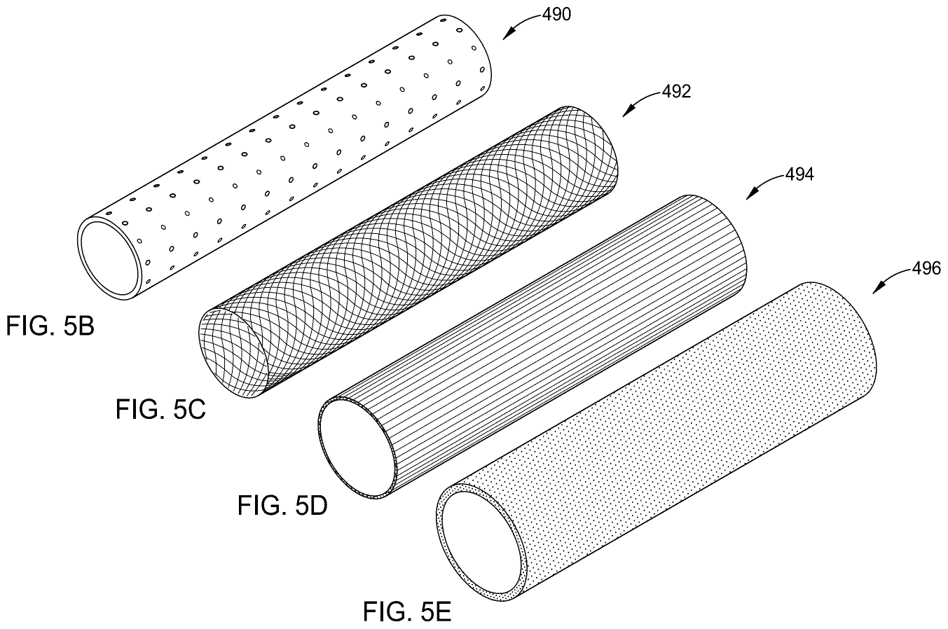

As shown in FIG. 4A, the organic-air redox flow battery 400 includes organic liquid inlet 425 to the housing 480 and outlet 446 from the housing 480. The housing 480 and tubes 470 form a shell-side space 434 (shown in FIG. 4B) delineated by the inside surface of the housing 480 and the outside surface of the tubes 470. Incoming organic liquid 444 flows into housing 480 via inlet 425 and flows within the housing 480 in the shell-side space 434 between the tubes 470 and the housing 480. The outgoing organic liquid 446 flows out of the shell-side space 434 via outlet 450. In FIG. 4A, the air 440, 442 flow and the organic liquid 444, 446 flow are shown to be in parallel. However, in some aspects, the air 440, 442 flows and the organic liquid 444, 446 flows may have a counter-flow arrangement. Additionally, while FIGS. 4A-4B depict the air 440 to be within the tubes 470 and the organic liquid 444 to be in the shell-side space 434 within the housing 480, the organic liquid may flow within the tubes 470 and the air may flow within the shell-side space 434 as discussed in more detail with respect to FIGS. 5A-5E.

Although not shown, it is to be understood that the organic-air redox flow battery 400 may include further additional components, such as baffles. Additionally, while the organic-air redox flow battery 400 in FIG. 4A is shown to have a straight tube 470 configuration, other tube 470 configurations are contemplated.

As shown in FIG. 4B, the tubes 470 may be arranged within the organic-air redox flow battery 400 in a regular, linear pattern. However, it is contemplated that the tubes 470 may be arranged in any regular or irregular pattern within the battery housing 480.

FIG. 5A depicts a schematic cross-sectional view of a tube 470 for the organic-air redox flow battery 400 in which certain aspects of the present disclosure may be applied. FIGS. 5B-5E depict schematic exploded views of material layers 590, 592, 594, 596 within the tube 470 for the organic-air redox flow battery 400 in which certain aspects of the present disclosure may be applied.

As shown in FIG. 5A, the tubes 470 may have a diameter 472. In some aspects, the diameter 572 used for the tubes 470 may be based on the application, the composition of the incoming air 440, the composition of the incoming organic liquid 444, the available space, and other considerations. The walls of tubes 470 defining the tube interior 432 may have a thickness 574. In some aspects, the thickness 574 used for the tubes 470 is based on the application, the composition of the incoming air 440, the composition of the incoming organic liquid 444, the available space, and other considerations. A spacing 576 may exist between each of the tubes 470, in part defining the shell-side space 434. In some aspects, the spacing 576 used may be based on the application, the composition of the incoming air 440, the composition of the incoming organic liquid 444, the available space, and other considerations.

As shown in FIGS. 5A-5E, the tubes 470 may include multiple layers 590, 592, 594, 596. As shown in FIG. 5A and FIG. 5B, perforated tubing layer 590 is the innermost layer of the tube 470. The perforated tubing layer 490 acts as a positive electrode terminal. The perforated tubing layer 590 is gas permeable, allowing the air 432 flowing within the tube 470 to pass through the perforated tubing layer 590. In some aspects, the perforated tubing layer 590 is hydro permeable.

As shown in FIG. 5A and FIG. 5C, a metal screen layer 592 is the next most innermost layer after the perforated tubing layer 590. The metal screen layer 592 provides mechanical and electrical contact between the perforated tubing layer 590 and the next layer, the oxygen electrode layer 594. The metal screen layer is gas permeable, allowing the air 432 flowing within the tube 470 to pass through the metal screen layer 592 to the oxygen electrode layer 594. In some aspects, the metal screen layer 592 is hydro permeable.

As shown in FIG. 5A and FIG. 5D, oxygen electrode layer 594, is the next innermost layer (and the second outermost layer). The oxygen electrode layer 594 be similar to the membrane electrode assemblies 150, 250 described in FIG. 1, FIGS. 2A-2B, and FIG. 3A.

As shown in FIG. 5A and FIG. 5E, a separator layer 596 is the outermost layer The separator layer 596 provides separation from the positive electrode terminal (perforated tubing 590) and the organic liquid flowing within the shell-side space 434 surrounding the tubes 470 (and the negative electrode terminal). In some aspects, the separator layer 596 is air impermeable and hydro impermeable.

Accordingly, incoming air 440 flowing into the housing 480 of the oxygen-air redox flow battery 400 and through the tube interior 432 of tubes 470 may pass through the perforated tubing layer 590 and the metal screen layer 592, where the redox reaction occurs with the oxygen electrode layer 594, while the organic liquid flows past the tubes 470 within the shell-side space 434. Resulting water from the air redox reaction may flow back into the tube interior 432.

According to certain aspects, in another configuration, the air may flow in the shell-side space 434 and the organic liquid may flow within the tubes 470. In this case, configuration of the layers 590, 592, 594, 596 would be reversed from the configuration shown in FIG. 5A, with the separator layer 596 as the innermost layer and the perforated tubing layer 590 as the outermost layer.

The disclosure relates to an organic-oxygen reduction-oxidation (redox) flow battery, comprising an organic-containing fluid flow space for flowing an organic-containing fluid including at least an organic redox-active species; an oxygen-containing fluid flow space for flowing an oxygen-containing fluid. It also includes one or more membrane electrode assemblies, each membrane electrode assembly comprising an oxygen electrode, wherein the oxygen electrode is configured to catalyze an oxygen reduction reaction (ORR) of oxygen of the oxygen-containing fluid and optionally an oxygen evolution reaction (OER); and a membrane, wherein the membrane separates the oxygen electrode from the organic-containing fluid flow space while allowing the transport of ions between the oxygen electrode and the organic-containing fluid flow space. The battery also comprises a positive electrode terminal electrically connected to at least one of the one or more membrane electrode assemblies; and a negative electrode terminal electrically connected to the organic-containing fluid, wherein the battery is configured to allow the transport of electrons between the positive and negative electrode.

The positive electrode terminal and the negative electrode terminal may be configured to generate an electrical current between the positive electrode terminal and the negative electrode terminal in response to a redox reaction between the oxygen-containing fluid and the organic-containing fluid, wherein the redox reaction includes the ORR of the oxygen at the oxygen electrode and an oxidation reaction of the redox active species of the organic-containing fluid.

The organic-oxygen redox flow battery may also be configured to generate an OER at the oxygen electrode and a reduction reaction in the organic-containing fluid, in response to an electrical current applied between the positive electrode terminal and the negative electrode terminal.

The organic-containing fluid may be selected to lose electrons and to release hydrogen ions or metallic ions in an oxidation reaction under ambient conditions. In an embodiment, the battery may be configured so that the hydrogen ions or the metallic ions are transported toward the oxygen electrode, while oxygen of the oxygen-containing fluid gains electrons in the ORR, forming an electrical current between the positive electrode terminal and the negative electrode terminal by the flow of electrons from the organic-containing fluid and to the oxygen-containing fluid. In such an embodiment, the ORR of the oxygen of the oxygen-containing fluid may result in at least one of: hydroxide or water byproduct, and wherein the oxidation reaction of the organic-containing fluid results in an organic fluid byproduct. In such an embodiment, the organic-oxygen redox flow battery may be configured to, when the electrical current is generated in response to the voltage applied to the positive electrode terminal cause the hydroxide or water byproduct to lose electrons in an oxidation reaction; and cause the organic-containing fluid byproduct to gain electrons in a reduction reaction. In such an embodiment, the oxidation reaction of the hydroxide or water byproduct may result in the oxygen-containing fluid, and wherein the reduction reaction of the organic-containing fluid byproduct may result in the organic-containing fluid.

In an embodiment, the flow battery may further comprise one or more housings, wherein the organic-containing fluid flow space is defined within the housing; each housing includes the membrane electrode assembly on both sides of the housing; each housing includes a metal current collector comprising the negative electrode terminal in a center of the housing; each housing includes a space between the metal current collector and the membrane electrode assembly, the space forming the organic-containing fluid flow space between the metal current collector and the membrane electrode assembly; and the oxygen-containing fluid flow space includes a gap between each individual housing allowing contact between the oxygen-containing fluid and the membrane electrode assemblies.

In an embodiment, the organic-oxygen redox flow battery may comprise an organic liquid circulation system configured to flow the organic-containing fluid through the organic-containing fluid flow space.

In an embodiment, the membrane is configured to prevent passage of the organic-containing fluid and water.

In an embodiment, the organic-containing fluid comprises at least one of: a quinone, an organic monomer, or an organic polymer. In such an embodiment, the organic-containing fluid may comprise at least one of: 2,5-Dihydroxy-1,4-benzoquinone (DHBQ), poly(2,5-dihydroxy-1,4-benzoquinone-3,6-methylene) (PDBM).

In an embodiment, the oxygen-containing fluid is ambient air.

In an embodiment, the flow battery further comprises one or more housings, wherein a first housing comprises a first membrane electrode assembly on a first side of the housing and a second membrane electrode assembly on the second side of the housing, wherein the positive electrode terminal electrically connected to the first membrane electrode assembly and the second membrane electrode assembly; a second housing disposed on the second side of the first housing. In this embodiment, the organic-containing fluid flow space is defined within the housing; the oxygen-containing fluid flow space includes a fluid flow layer on a first side of the second housing allowing contact between the oxygen-containing fluid and the second membrane electrode assemblies. In such an embodiment, the metal current collector is located under the fluid flow layer on the first side of the second housing, the metal current collecting comprising the negative electrode terminal and in contact with the second membrane electrode assembly; and the battery includes an opening in the second side of the second housing allowing contact between the metal current collector and the organic-containing fluid including at least an organic redox-active species. In such an embodiment, the battery may further comprise a sealing element around the opening, wherein the sealing element is configured to seal the organic-containing fluid within the second housing.

In another embodiment, the flow battery further comprises a tubular battery housing; and a plurality of tubes within the tubular battery housing, wherein the tubular battery housing and the plurality of tubes define a shell-side space between the plurality of tubes and the tubular battery housing. In such an embodiment, the tubular battery housing may include an inlet to the shell-side space; an outlet from the shell-side space; an inlet to each of the plurality of tubes; and an outlet from each of the plurality of tubes. In such a first alternative embodiment, the organic fluid flow space may be defined within the shell-side space; each of the plurality of tubes comprises a tubular wall defining the oxygen-containing fluid flow space within the plurality of tubes; the tubular wall includes an outer layer comprising the membrane; and the tubular wall includes an oxygen electrode layer, under the outer layer, comprising the oxygen electrode. In such an embodiment, the tubular wall may further include an inner perforated tubing layer; an a metal screen layer between the inner perforated tubing layer and the oxygen electrode layer. In such an embodiment, the positive electrode terminal may be electrically connected to the inner perforated tubing layer, and the negative electrode terminal may be electrically connected to the organic fluid. In another alternative embodiment, the oxygen-containing fluid flow space is defined within the shell-side space; each of the plurality of tubes comprises a tubular wall defining the organic fluid flow space within the plurality of tubes; the tubular wall includes an inner layer comprising the membrane; and the tubular wall includes an oxygen electrode layer, over the inner layer, comprising the oxygen electrode. In such an embodiment, the tubular wall further includes an outer perforated tubing layer; and a metal screen layer between the outer perforated tubing layer and the oxygen electrode layer. In such an embodiment, the positive electrode terminal is electrically connected to the outer perforated tubing layer, and the negative electrode terminal is electrically connected to the organic fluid.

The disclosure also relates to an organic-oxygen reduction-oxidation (redox) flow battery, comprising a tubular battery housing; a plurality of tubes within the tubular battery housing, each of the plurality of tubes defining one of an oxygen-containing fluid flow space for flowing an oxygen-containing fluid or an organic fluid flow space for flowing an organic-containing fluid including at least an organic redox-active species. The tubular battery housing and the plurality of tubes define the other one of the oxygen-containing fluid flow space or the organic fluid flow space between the plurality of tubes and the tubular battery housing. Each of the plurality of tubes comprises a membrane electrode assembly, each membrane electrode assembly comprising an oxygen electrode, wherein the oxygen electrode is configured to catalyze an oxygen reduction reaction (ORR) of oxygen of the oxygen-containing fluid and optionally an oxygen evolution reaction (OER); and a membrane, wherein the membrane separates the oxygen electrode from the organic-containing fluid flow space while allowing the transport of ions between the oxygen electrode and the organic-containing fluid flow space; a positive electrode terminal electrically connected to at least one of the one or more membrane electrode assemblies; and a negative electrode terminal electrically connected to the organic-containing fluid, wherein the battery is configured to allow the transport of electrons between the positive and negative electrode.

The disclosure also relates to a method of charging and discharging an organic-oxygen reduction-oxidation (redox) flow battery, comprising: flowing an organic-containing fluid including at least an organic redox-active species through an organic-containing fluid flow space of the battery and past a current collector of the battery to cause the organic redox-active species to lose electrons and to release hydrogen ions or associated metallic ions and generate hydroxide or water byproduct in an oxidation reaction; flowing an oxygen-containing fluid through an oxygen-containing fluid flow space and past a membrane electrode assembly to cause oxygen of the oxygen-containing fluid to gain electrons and generate hydroxide or water in a reduction reaction;discharging an electrical current formed by the loss of electrons from the organic redox-active species of the organic fluid and the gain of electrons by the oxygen of the oxygen-containing fluid from the battery via a positive electrode terminal of the battery and a negative electrode terminal of the battery, respectively; and vapplying a voltage to the positive electrode terminal to generate an electrical current across the positive electrode terminal and the negative electrode terminal to cause the hydroxide or water byproduct to lose electrons and to release hydrogen ions in an oxidation reaction and the organic fluid byproduct to gain electrons and hydrogen ions in a reduction reaction.

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of. a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An organic-oxygen reduction-oxidation (redox) flow battery, comprising:
an organic-containing fluid flow space for flowing an organic-containing fluid including at least an organic redox-active species;
an oxygen-containing fluid flow space for flowing an oxygen-containing fluid;
one or more membrane electrode assemblies, each membrane electrode assembly comprising:
an oxygen electrode, wherein the oxygen electrode is configured to catalyze an oxygen reduction reaction (ORR) of oxygen of the oxygen-containing fluid and optionally an oxygen evolution reaction (OER); and
a membrane, wherein the membrane separates the oxygen electrode from the organic-containing fluid flow space while allowing the transport of ions between the oxygen electrode and the organic-containing fluid flow space;
a positive electrode terminal electrically connected to at least one of the one or more membrane electrode assemblies; and
a negative electrode terminal electrically connected to the organic-containing fluid, wherein the battery is configured to allow the transport of electrons between the positive and negative electrode.

2. The organic-oxygen redox flow battery of claim 1, wherein the positive electrode terminal and the negative electrode terminal are configured to generate an electrical current between the positive electrode terminal and the negative electrode terminal in response to a redox reaction between the oxygen-containing fluid and the organic-containing fluid, wherein the redox reaction includes the ORR of the oxygen at the oxygen electrode and an oxidation reaction of the redox active species of the organic-containing fluid.

3. The organic-oxygen redox flow battery of claim 1, wherein the organic-oxygen redox flow battery is configured to generate an OER at the oxygen electrode and a reduction reaction in the organic-containing fluid, in response to an electrical current applied between the positive electrode terminal and the negative electrode terminal.

4. The organic-oxygen redox flow battery of claim 1, wherein the organic-containing fluid is selected to lose electrons and to release hydrogen ions or metallic ions in an oxidation reaction under ambient conditions.

5. The organic-oxygen redox flow battery of claim 4, wherein the battery is configured so that the hydrogen ions or the metallic ions are transported toward the oxygen electrode, while oxygen of the oxygen-containing fluid gains electrons in the ORR, and wherein an electrical current is formed between the positive electrode terminal and the negative electrode terminal by the flow of electrons from the organic-containing fluid and to the oxygen-containing fluid.

6. The organic-oxygen redox flow battery of claim 5, wherein the ORR of the oxygen of the oxygen-containing fluid results in at least one of: hydroxide or water byproduct, and wherein the oxidation reaction of the organic-containing fluid results in an organic fluid byproduct.

7. The organic-oxygen redox flow battery of claim 1, further comprising one or more housings, wherein:
the organic-containing fluid flow space is defined within the housing;
each housing includes the membrane electrode assembly on both sides of the housing;
each housing includes a metal current collector comprising the negative electrode terminal in a center of the housing;
each housing includes a space between the metal current collector and the membrane electrode assembly, the space forming the organic-containing fluid flow space between the metal current collector and the membrane electrode assembly; and
the oxygen-containing fluid flow space includes a gap between each individual housing allowing contact between the oxygen-containing fluid and the membrane electrode assemblies.

8. The organic-oxygen redox flow battery of claim 1, further comprising an organic liquid circulation system configured to flow the organic-containing fluid through the organic-containing fluid flow space.

9. The organic-oxygen redox flow battery of claim 1, wherein the organic-containing fluid comprises at least one of: a quinone, an organic monomer, or an organic polymer.

10. The organic-oxygen redox flow battery of claim 9, wherein the organic-containing fluid comprises at least one of: 2,5-Dihydroxy-1,4-benzoquinone (DHBQ), poly(2,5-dihydroxy-1,4-benzoquinone-3,6-methylene) (PDBM).

11. The organic-oxygen redox flow battery of claim 1, wherein the oxygen-containing fluid is ambient air.

12. The organic-oxygen redox flow battery of claim 1, further comprising an organic liquid circulation system configured to flow the organic-containing fluid through the organic-containing fluid flow space, further comprising one or more housings, wherein:
a first housing comprises a first membrane electrode assembly on a first side of the housing and a second membrane electrode assembly on the second side of the housing, wherein the positive electrode terminal electrically connected to the first membrane electrode assembly and the second membrane electrode assembly;
a second housing disposed on the second side of the first housing;
the organic-containing fluid flow space is defined within the housing;
the oxygen-containing fluid flow space includes a fluid flow layer on a first side of the second housing allowing contact between the oxygen-containing fluid and the second membrane electrode assemblies;
the metal current collector under the fluid flow layer on the first side of the second housing, the metal current collecting comprising the negative electrode terminal and in contact with the second membrane electrode assembly; and
an opening in the second side of the second housing allowing contact between the metal current collector and the organic-containing fluid including at least an organic redox-active species.

13. The organic-oxygen redox flow battery of claim 12, further comprising a sealing element around the opening, wherein the sealing element is configured to seal the organic-containing fluid within the second housing.

14. The organic-oxygen redox flow battery of claim 1, further comprising:
a tubular battery housing; and
a plurality of tubes within the tubular battery housing, wherein the tubular battery housing and the plurality of tubes define a shell-side space between the plurality of tubes and the tubular battery housing.

15. The organic-oxygen redox flow battery of claim 14, wherein:
the organic fluid flow space is defined within the shell-side space;
each of the plurality of tubes comprises a tubular wall defining the oxygen-containing fluid flow space within the plurality of tubes;
the tubular wall includes an outer layer comprising the membrane; and
the tubular wall includes an oxygen electrode layer, under the outer layer, comprising the oxygen electrode.

16. The organic-oxygen redox flow battery of claim 15, wherein the tubular wall further includes:
an inner perforated tubing layer; and
a metal screen layer between the inner perforated tubing layer and the oxygen electrode layer.

17. The organic-oxygen redox flow battery of claim 14, wherein:
the oxygen-containing fluid flow space is defined within the shell-side space;
each of the plurality of tubes comprises a tubular wall defining the organic fluid flow space within the plurality of tubes;
the tubular wall includes an inner layer comprising the membrane; and
the tubular wall includes an oxygen electrode layer, over the inner layer, comprising the oxygen electrode.

18. The organic-oxygen redox flow battery of claim 17, wherein the tubular wall further includes:
an outer perforated tubing layer; and
a metal screen layer between the outer perforated tubing layer and the oxygen electrode layer.

19. An organic-oxygen reduction-oxidation (redox) flow battery, comprising:
a tubular battery housing;
a plurality of tubes within the tubular battery housing, each of the plurality of tubes defining one of an oxygen-containing fluid flow space for flowing an oxygen-containing fluid or an organic fluid flow space for flowing an organic-containing fluid including at least an organic redox-active species, wherein the tubular battery housing and the plurality of tubes define the other one of the oxygen-containing fluid flow space or the organic fluid flow space between the plurality of tubes and the tubular battery housing, and wherein each of the plurality of tubes comprises a membrane electrode assembly, each membrane electrode assembly comprising:
an oxygen electrode, wherein the oxygen electrode is configured to catalyze an oxygen reduction reaction (ORR) of oxygen of the oxygen-containing fluid and optionally an oxygen evolution reaction (OER); and
a membrane, wherein the membrane separates the oxygen electrode from the organic-containing fluid flow space while allowing the transport of ions between the oxygen electrode and the organic-containing fluid flow space;
a positive electrode terminal electrically connected to at least one of the one or more membrane electrode assemblies; and
a negative electrode terminal electrically connected to the organic-containing fluid, wherein the battery is configured to allow the transport of electrons between the positive and negative electrode.

20. A method of charging and discharging an organic-oxygen reduction-oxidation (redox) flow battery, the method comprising:
flowing an organic-containing fluid including at least an organic redox-active species through an organic-containing fluid flow space of the battery and past a current collector of the battery to cause the organic redox-active species to lose electrons and to release hydrogen ions or associated metallic ions and generate hydroxide or water byproduct in an oxidation reaction;
flowing an oxygen-containing fluid through an oxygen-containing fluid flow space and past a membrane electrode assembly to cause oxygen of the oxygen-containing fluid to gain electrons and generate hydroxide or water in a reduction reaction;
discharging an electrical current formed by the loss of electrons from the organic redox-active species of the organic fluid and the gain of electrons by the oxygen of the oxygen-containing fluid from the battery via a positive electrode terminal of the battery and a negative electrode terminal of the battery, respectively; and
applying a voltage to the positive electrode terminal to generate an electrical current across the positive electrode terminal and the negative electrode terminal to cause the hydroxide or water byproduct to lose electrons and to release hydrogen ions in an oxidation reaction and the organic fluid byproduct to gain electrons and hydrogen ions in a reduction reaction.
